(19) United States
(12) Patent Application Publication
(10) Pub. No.: US 2026/0180455 A1
(43) Pub. Date: Jun. 25, 2026

(54) FLYBACK CONVERTER AND CONTROL CIRCUIT, CONTROL METHOD THEREOF

(71) Applicant: Joulwatt Technology Co., Ltd., Hangzhou City (CN)

(72) Inventor: Xiangyong XU, Hangzhou (CN)

(21) Appl. No.: 19/422,662

(22) Filed: Dec. 17, 2025

(30) Foreign Application Priority Data
Dec. 25, 2024 (CN) 202411931805.8

(51) Int. Cl. H02M 3/335; H02M 1/00

(52) U.S. Cl. CPC H02M 3/33571; H02M 1/0058

(57) ABSTRACT

This disclosure proposes a flyback converter, and a control circuit and a control method thereof. The control method comprises: working in a discontinuous conduction mode while the load state is light load; working in a boundary conduction mode while the load state is heavy load; working in a hybrid conduction mode while the load state is between light load and heavy load. A hybrid conduction mode cycle comprises N switching cycles, with the first N-1 switching cycles working in the boundary conduction mode while the Nth switching cycle working in the discontinuous conduction mode. Each switching cycle in the hybrid conduction mode cycle is controlled to work in the boundary conduction mode or the discontinuous conduction mode according to a set maximum value of the hybrid conduction mode cycle and a set first duty cycle. Each switching cycle in the hybrid conduction mode is adaptively control, thereby improving system efficiency.

### CROSS-REFERENCE TO RELATED APPLICATIONS

This present disclosure claims priority to a Chinese patent application No. 202411931805.8, filed on December 25, 2024, and entitled "Flyback Converter and Control Circuit, Control Method thereof", the entire contents of which are incorporated herein by reference, including the specification, claims, drawings and abstract.

### FIELD OF TECHNOLOGY

The present disclosure relates to a field of power electronics technology, and more specifically, to a flyback converter, a control circuit and a control method thereof.

### BACKGROUND

The flyback converter has the characteristics of simple circuit structure, electrical isolation of input and output, wide voltage regulation range, and easy multi-channel output, making it suitable as an auxiliary switching power supply in power electronic devices and be widely used.

The flyback converter provides power to the load through the process of energy storage and release. The selection of its working mode depends on the demand of the load and the working conditions of the circuit. As the load changes, the flyback converter improves system efficiency by switching the corresponding operating mode. Generally, during heavy load, the flyback converter works in the boundary conduction mode, and as the load decreases, the flyback converter works in the discontinuous conduction mode. At present, zero voltage conduction is achieved in the discontinuous conduction mode by conducting the second switch of the flyback converter once outside the conduction head of the first switch of the flyback converter, thereby improving the efficiency of the flyback converter. However, due to the additional conduction of the second transistor, it actually increases the switching loss, which makes the efficiency not the optimal.

Therefore, it is necessary to provide improved technical solutions to overcome the above-mentioned technical problems in existing technologies.

### SUMMARY

In view of this, the purpose of the present disclosure is to provide a flyback converter, a control circuit and control method thereof to solve the problems in the prior art.

According to a first aspect of the present disclosure, a control method of a flyback converter is provided, comprising: obtaining a load state of the flyback converter; working in an discontinuous conduction mode while the load state is light load; working in a boundary conduction mode while the load state is heavy load; and working in a hybrid conduction mode while the load state is between light load and heavy load; a hybrid conduction mode cycle comprises N switching cycles, with the first N-1 switching cycles working in the boundary conduction mode while the Nth switching cycle working in the discontinuous conduction mode; wherein each switching cycle in the hybrid conduction mode cycle is controlled to work in the boundary conduction mode or the discontinuous conduction mode according to a set maximum value of the hybrid conduction mode cycle and a set first duty cycle, where N is a positive integer.

Optionally, controlling each switching cycle in the hybrid conduction mode cycle to work in the boundary conduction mode or the discontinuous conduction mode according to the set maximum value of the hybrid conduction mode cycle and the set first duty cycle comprises: obtaining the moment when the magnetizing inductance current of the flyback converter drops to zero in each switching cycle of the hybrid conduction mode cycle; and while the duration between the start time of the hybrid conduction mode cycle and the moment when the magnetizing inductance current of the switching cycle drops to zero is greater than the time threshold, controlling the switching cycle to work in the discontinuous conduction mode; the time threshold is equal to half of the product of the maximum value of the hybrid conduction mode cycle and the first duty cycle.

Optionally, it further comprises: while the duration between the start time of the hybrid conduction mode cycle and the moment when the magnetizing inductance current drops to zero during the switching cycle is equal to the time threshold, controlling the switching cycle to work in either the boundary conduction mode or the discontinuous conduction mode; while the duration between the start time of the hybrid conduction mode cycle and the moment when the magnetizing inductance current drops to zero during the switching cycle is less than the time threshold, controlling the switching cycle to work in the boundary conduction mode.

Optionally, the flyback converter comprises a first transistor and a second transistor, and controlling the switching cycle to work in the boundary conduction mode under the hybrid conduction mode comprises: controlling the first transistor to turn on at the beginning of the switching cycle; controlling the second transistor to turn on after the first transistor is turned off; controlling the second transistor to turn off by delaying a second time when the magnetizing inductance current drops to zero during the switching cycle.

Optionally, the flyback converter comprises a first transistor and a second transistor, and controlling the switching cycle to work in the discontinuous conduction mode under the hybrid conduction mode comprises: controlling the first transistor to turn on at the beginning of the switching cycle; controlling the second transistor to turn on after the first transistor is turned off; at the moment when the magnetizing inductance current drops to zero during the switching cycle, controlling the second transistor to turn off and keeping the first transistor turned off until the hybrid conduction mode cycle ends.

Optionally, the control method further comprises: obtaining a first time during the hybrid conduction mode cycle, which starts from the beginning of the hybrid conduction mode cycle and ends at the moment when the magnetizing inductance current of the flyback converter drops to zero during the Nth switching cycle; obtaining the hybrid conduction mode cycle based on the first time and the first duty cycle.

Optionally, the hybrid conduction mode cycle is the quotient of the first time and the first duty cycle.

Optionally, the hybrid conduction mode cycle is further obtained based on the maximum value of the hybrid conduction mode cycle; when the quotient of the first time and the first duty cycle is less than the maximum value of the hybrid conduction mode cycle, the hybrid conduction mode cycle is the quotient of the first time and the first duty cycle; otherwise, the hybrid conduction mode cycle is the maximum value of the hybrid conduction mode cycle.

Optionally, the method of obtaining the moment when the magnetizing inductance current of the flyback converter drops to zero in each switching cycle within the hybrid conduction mode cycle comprises: performing volt second balance detection in each switching cycle to obtain volt second balance time, which is used as the time of detecting that the magnetizing inductance current drops to zero; wherein the volt second balance time represents that the charge flowing out of the auxiliary winding during the conduction period of the first transistor of the flyback converter is equal to the charge flowing into the auxiliary winding during the conduction period of the second transistor of the flyback converter.

Optionally, the method of obtaining the moment when the magnetizing inductance current of the flyback converter drops to zero during the Nth switching cycle comprises: performing volt second balance detection within the Nth switching cycle to obtain the volt second balance time, which is used as the time detecting that the magnetizing inductance current drops to zero; the volt second balance time represents that the charge flowing out of the auxiliary winding during the conduction period of the first transistor of the flyback converter is equal to the charge flowing into the auxiliary winding during the conduction period of the second transistor of the flyback converter; or, detecting the moment when the slope of the signal representing the auxiliary winding voltage first reaches the slope threshold at the Nth switching cycle, and using it as the moment when the magnetizing inductance current drops to zero, wherein the slope threshold is negative.

Optionally, obtaining the load state of the flyback converter comprises: generating an error compensation signal based on the output feedback signal of the flyback converter; and obtaining the load state based on the error compensation signal, wherein, the load state is heavy load while the error compensation signal is greater than a first set threshold, and the load state is light load while the error compensation signal is less than a second set threshold, the load state is between light load and heavy load while the error compensation signal is less than the first set threshold and greater than the second set threshold, and the first set threshold is greater than the second set threshold.

Optionally, the control method further comprises: in the hybrid conduction mode, setting the first duty cycle according to the error compensation signal, wherein while the error compensation signal is greater than the second set threshold and less than the first set threshold, the first duty cycle increases as the error compensation signal increases.

Optionally, while the error compensation signal is equal to the first set threshold, the first duty cycle has a maximum value, and the maximum value of the first duty cycle is 100%.

Optionally, the peak current suddenly increases while the error compensation signal drops to the first set threshold.

According to the second aspect of the present invention, there is provided a control circuit of a flyback converter, the flyback converter comprising a first transistor and a second transistor, wherein the control circuit comprises: a mode control circuit, obtaining a load state of the flyback converter, controlling it to work in the discontinuous conduction mode while the load state is light load, controlling it to work in the boundary conduction mode while the load state is heavy load, and controlling it to work in the hybrid conduction mode while the load state is between light load and heavy load; the hybrid conduction mode cycle comprises N switching cycles, with the first N-1 switching cycles working in the boundary conduction mode and the Nth switching cycle working in the discontinuous conduction mode; the mode control circuit also controls each switching cycle within the hybrid conduction mode cycle to work in either the boundary conduction mode or the discontinuous conduction mode based on the set maximum value of the hybrid conduction mode cycle and the set first duty cycle, where N is a positive integer; and a switch control circuit, connected to the mode control circuit, controlling the switching states of the first transistor and the second transistor.

Optionally, it further comprises: a current zero crossing detection circuit, obtaining the moment when the magnetizing inductance current of the flyback converter drops to zero in each switching cycle of the hybrid conduction mode cycle; while the duration between the start of the hybrid conduction mode cycle and the moment when the magnetizing inductance current of the switching cycle drops to zero is greater than a time threshold, the mode control circuit controls the switching cycle to operate in the discontinuous conduction mode; the time threshold is equal to half of the product of the maximum value of the hybrid conduction mode cycle and the first duty cycle.

Optionally, it further comprises: an output feedback circuit, generating an error compensation signal based on the output feedback signal of the flyback converter; the mode control circuit obtains the load state of the flyback converter based on the error compensation signal; wherein, while the error compensation signal is greater than a first set threshold, the load state is heavy load; while the error compensation signal is less than a second set threshold, the load state is light load; while the error compensation signal is less than the first set threshold and greater than the second set threshold, the load state is between light load and heavy load; the first set threshold is greater than the second set threshold.

Optionally, it further comprises: a cycle control circuit, obtaining the hybrid conduction mode cycle based on a first time and the first duty cycle, wherein, the mode control circuit obtains the first time, which starts from the beginning of the hybrid conduction mode cycle and ends at the moment when the magnetizing inductance current of the flyback converter drops to zero in the Nth switching cycle.

Optionally, the cycle control circuit comprises: a first capacitor unit, comprising a first capacitor; the first capacitor unit generates a first current within the first time and discharges the first capacitor at the beginning of each hybrid conduction mode cycle, and then charges the first capacitor by the first current; a second capacitor unit, comprising a second capacitor; the second capacitor unit provides a second current and discharges the second capacitor at the beginning of each hybrid conduction mode cycle, and then charges the second capacitor through the second current; and a comparator, generating a periodic control signal based on the comparison result between the voltage across the first capacitor and the voltage across the second capacitor, and the periodic control signal represents a hybrid conduction mode cycle or a discontinuous conduction mode cycle, wherein, the quotient of the second current and the first current is the first duty cycle, and the capacitance values of the first capacitor and the second capacitor are equal.

Optionally, the first capacitor unit further comprises: a first resistor; a first current source, comprising an eighth transistor and a ninth transistor; the control terminal of the eighth transistor is connected to its own first terminal and connected to the power supply voltage through the first resistor, the control terminal of the ninth transistor is connected to the control terminal of the eighth switch tube, and the first terminal of the ninth transistor is connected to the power supply voltage, the second terminal of the ninth transistor is connected to the first terminal of the first capacitor, and the second terminal of the first capacitor is grounded; a third transistor, the control end of which receives a first control signal, the first end of which is connected to the second end of the eighth transistor, and the second end of which is grounded; a fourth transistor, the first end of which is connected to the first end of the first capacitor, the second end of which is connected to the second end of the first capacitor, and the control terminal of which receives a second control signal, the second capacitor unit further comprises: a second resistor; a second current source, comprising a fifth transistor and a sixth transistor, wherein the control terminal of the fifth transistor is connected to its own first terminal and connected to the power supply voltage via the second resistor, the second terminal of the fifth transistor is grounded, the control terminal of the sixth transistor is connected to the control terminal of the fifth transistor, the first terminal of the sixth transistor is connected to the power supply voltage, the second terminal of the sixth transistor is connected to the first terminal of the second capacitor, and the second terminal of the second capacitor is grounded; a seventh transistor, the first end of which is connected to the first end of the second capacitor, the second end of which is connected to the second end of the second capacitor, and the control terminal of which receives a second control signal, wherein, the effective state of the first control signal is maintained for the first time, the second control signal is a pulse signal at the beginning of each hybrid conduction mode cycle, the resistance values of the first resistor and the second resistor are equal, and the quotient of the mirror coefficients of the second current source and the first current source is the first duty cycle.

According to the third aspect of the present disclosure, there is provided a flyback converter comprising the above-mentioned control circuit of a flyback converter.

The flyback converter and the control circuit and control method thereof provided in this disclosure, by obtaining the load state of the flyback converter, control the flyback converter to work in different modes under different load states. while the load state is between light load and heavy load, it works in the hybrid conduction mode. The hybrid conduction mode cycle comprises N switching cycles, with the first N-1 switching cycles working in the boundary conduction mode and the Nth switching cycle working in discontinuous conduction mode. This application controls each switching cycle within the hybrid conduction mode cycle to work in the boundary conduction mode or the discontinuous conduction mode by the set maximum value of the hybrid conduction mode cycle and the set first duty cycle, so as to adaptively control each switching cycle in the hybrid conduction mode and improve the system efficiency of the flyback converter under load conditions between light load and heavy load.

Furthermore, in the present application, while the error compensation signal drops to the first set threshold, the peak current suddenly increases to add control hysteresis and avoid switching back and forth between the boundary conduction mode and hybrid conduction mode.

### BRIEF DESCRIPTION OF THE DRAWINGS

FIG. 1 shows a structural schematic view of a flyback converter provided according to an embodiment of the present application;

FIG. 2 shows a structural schematic view of another flyback converter provided according to an embodiment of the present application;

FIG. 3 shows a waveform diagram of a peak current and a first duty cycle in the control circuit of the flyback converter provided according to an embodiment of the present application;

FIGS. 4A to 4E respectively show waveform diagrams of the flyback converter in different hybrid conduction mode cycles under the hybrid conduction mode provided in the present embodiment;

FIG. 5 shows a waveform schematic diagram of a volt second balance detection circuit in the flyback converter provided according to an embodiment of the present application;

FIG. 6 shows a schematic diagram of a cycle control circuit in the flyback converter provided according to an embodiment of the present application;

FIG. 7 shows a waveform diagram of a cycle control circuit in a flyback converter

FIG. 8 shows a flowchart of a control method of the flyback converter provided according to an embodiment of the present application;

FIG. 9 shows a waveform diagram of another peak current in the control circuit of the flyback converter provided according to an embodiment of the present application

FIG. 10 shows a waveform diagram of another peak current in the control circuit of the flyback converter provided according to an embodiment of the present application;

FIG. 11 shows a waveform diagram of another peak current in the control circuit of the flyback converter provided according to an embodiment of the present application;

FIG. 12 shows a structural schematic view of another flyback converter according to an embodiment of the present application;

FIG. 13 shows a structural schematic view of another flyback converter according to an embodiment of the present application;

FIG. 14 shows a structural schematic view of another flyback converter according to an embodiment of the present application.

### DETAILED DESCRIPTION

Various embodiments of the present disclosure will be described in more details below with reference to the accompanying drawings. In each accompanying drawing, the same elements are represented by the same or similar reference numerals.

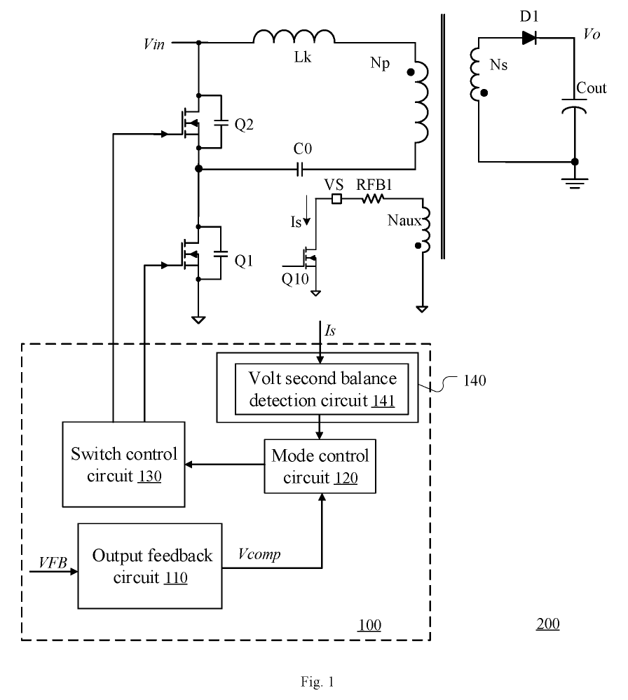

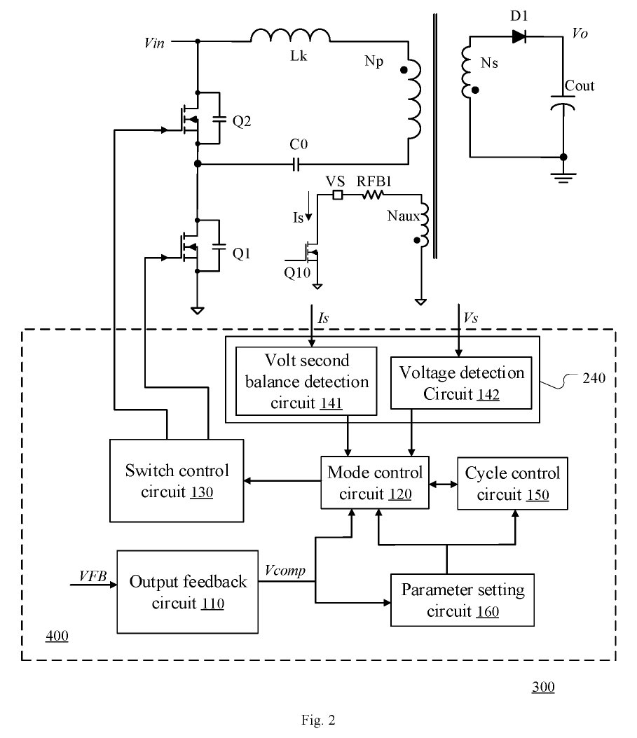

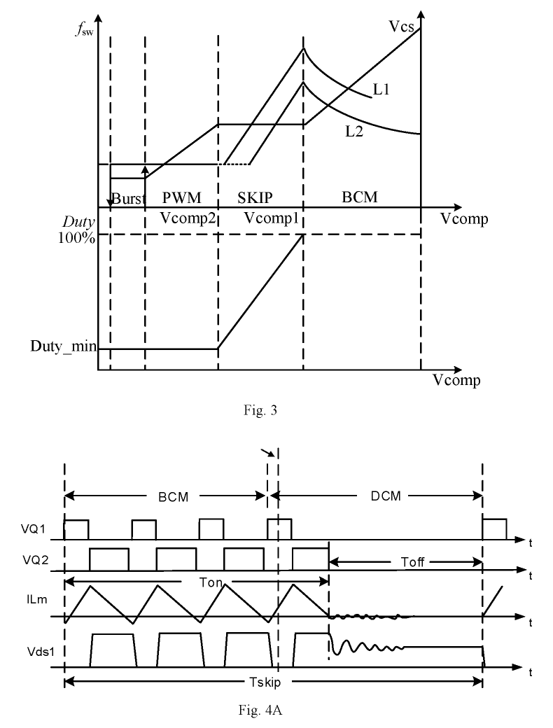

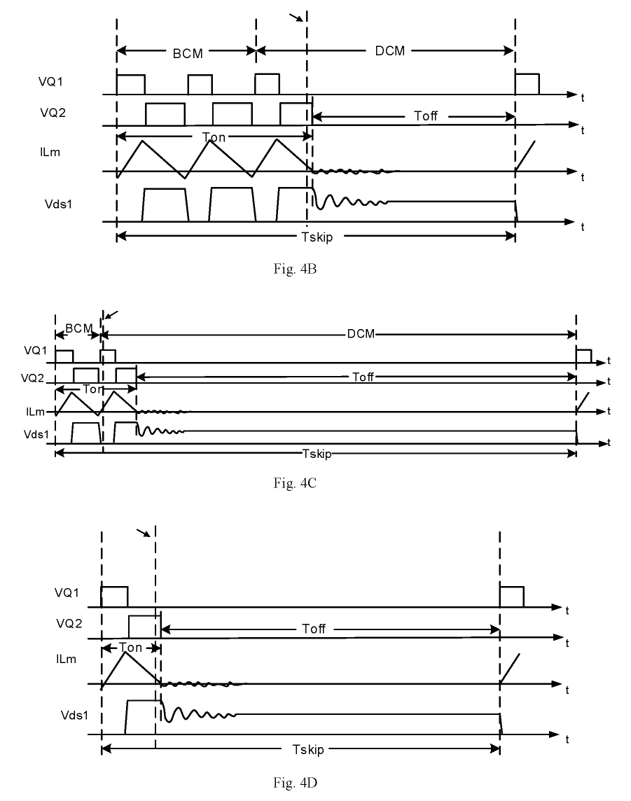

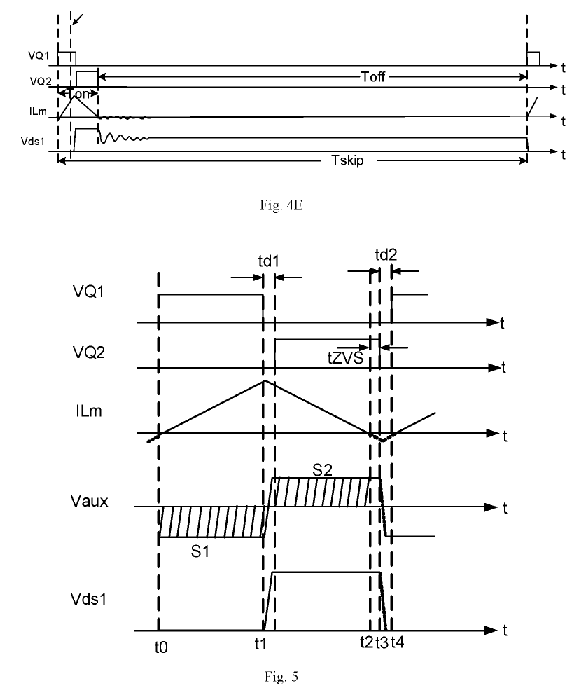

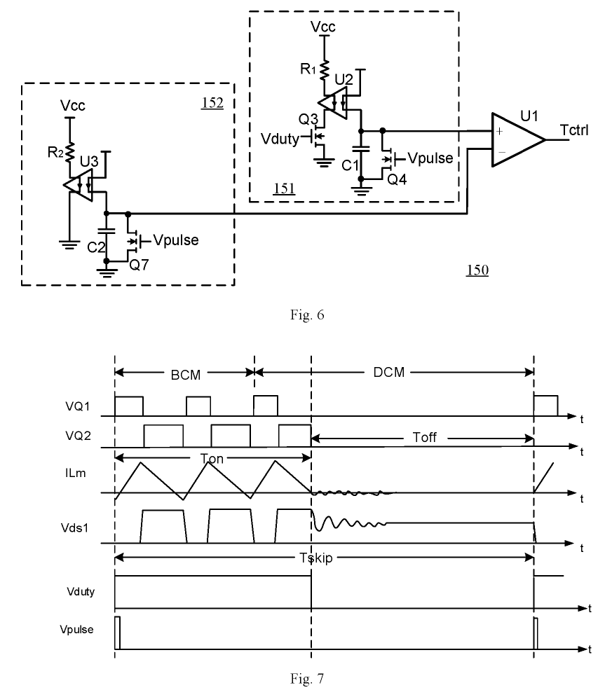

FIG. 1 shows a structural schematic view of a flyback converter provided according to an embodiment of the present application. FIG. 2 shows a structural schematic view of another flyback converter provided according to an embodiment of the present application. FIG. 3 shows a waveform diagram of a peak current and a first duty cycle in the control circuit of the flyback converter provided according to an embodiment of the present application. FIGS. 4A to 4E respectively show waveform diagrams of the flyback converter in different hybrid conduction mode cycles under the hybrid conduction mode provided in the present embodiment. FIG. 5 shows a waveform schematic diagram of a volt second balance detection circuit in the flyback converter provided according to an embodiment of the present application. FIG. 6 shows a schematic diagram of a cycle control circuit in the flyback converter provided according to an embodiment of the present application. FIG. 7 shows a waveform diagram of a cycle control circuit in a flyback converter provided according to an embodiment of the present application.

Refer to FIG. 1, the flyback converter 200 in this embodiment is, e.g., an asymmetric half bridge flyback converter, which comprises a transformer T with a primary winding Np and a secondary winding Ns, transistors Q1 and Q2, and a first inductor Lk and a capacitor C0 located on the primary side of the flyback converter 200, and a diode D1 and an output capacitor Cout located on the secondary side of the flyback converter 200.

On the primary side, the second transistor Q2 and the first transistor Q1 are sequentially connected in series between the input voltage Vin and the reference ground. In one possible embodiment, both the first transistor Q1 and the second transistor Q2 are NMOS field effect transistors. The first inductor Lk, the primary winding Np of transformer T, and capacitor C0 are connected in series between the drain and source of the second transistor Q2, forming a resonant circuit together in the conducting state of the second transistor Q2. The equivalent inductance of the primary winding of transformer T in the resonant circuit is the magnetizing inductance. It should be noted that in low-power power applications, the leakage inductance of transformer T can be used instead of the first inductance Lk.

On the secondary side, diode D1 and the secondary winding Ns of transformer T are sequentially connected in series between the voltage output terminal and the ground. The anode of diode D1 is connected to the anonymous end of the secondary winding Ns, thereby rectifying the induced voltage in reverse phase with the magnetizing voltage of transformer T to provide a DC output voltage Vo. The output capacitor Cout is connected between the voltage output terminal and the ground, filtering the DC output voltage Vo to obtain a smooth voltage waveform.

The flyback converter 200 further comprises an auxiliary winding Naux and a sampling terminal VS to obtain a signal Vs representing the auxiliary winding voltage Vaux. Exemplarily, a resistor RFB1 is also included between the auxiliary winding Naux and the sampling terminal VS. Furthermore, a transistor Q10 is also included, which is connected between the sampling terminal VS and the ground. In other embodiments, a sampling resistor connected between the source of the first switching transistor Q1 and the ground is also included to obtain the inductor current sampling signal.

The working process of flyback converter 200 comprises: energy storage, when the first transistor Q1 is turned on, the sampling signal of the inductance current of the primary winding rises, the transformer T stores energy, and the load is powered by the output capacitor Cout; energy release, when the first transistor Q1 is turned off, the inductance induced voltage of the primary winding is reversed, diode D1 is turned on, and the energy in transformer T is supplied to the load through diode D1, and meanwhile the output capacitor Cout is charged to replenish the energy just lost.

The control circuit 100 in the flyback converter 200 is used to obtain the load state of the flyback converter 200 and controls it to work under different modes based on the load state. The control circuit 100 comprises a mode control circuit 120 and a switch control circuit 130.

The mode control circuit 120 obtains the load state of the flyback converter and outputs a mode control signal based on the load state. The mode control signal controls the flyback converter 200 to work in the discontinuous conduction mode while the load state is light load, controls the flyback converter 200 to work in the boundary conduction mode while the load state is heavy load, and controls the flyback converter 200 to work in the hybrid conduction mode while the load state is between light load and heavy load. Wherein, the hybrid conduction mode cycle Tskip comprises N switching cycles, where N is a positive integer. Schematically, the first N-1 switching cycles operate in the boundary conduction mode, and the Nth switching cycle operates in the discontinuous conduction mode. The mode control circuit 120 also controls each switching cycle in the hybrid conduction mode cycle to work in the boundary conduction mode (BCM) or discontinuous conduction mode (DCM) based on the set maximum value Tmax of the hybrid conduction mode cycle and the set first duty cycle Duty.

Refer to FIGS. 3 and 4A-4E, schematically, in the case of heavy load, the flyback converter works in the boundary conduction mode (BCM). As the load decreases, the flyback converter operates in hybrid conduction mode (SKIP) between the heavy light and the light load. Furthermore, the hybrid conduction mode cycle Tskip comprises N switching cycles, for example, the first N-1 switching cycles work in the boundary conduction mode (BCM), while the Nth switching cycle works in the discontinuous conduction mode (DCM). For example, refer to FIGS. 4A-4C, the hybrid conduction mode cycle Tskip with N>1 is shown. As the load changes, the number of switch cycles in the hybrid conduction mode cycle also varies. As the load decreases, the cycle of the flyback converter working in the hybrid conduction mode can be as shown in FIG. 4A, which comprises 3 boundary conduction mode switching cycles and 1 discontinues conduction mode switching cycle, or as shown in FIG. 4B, which comprises 2 boundary conduction mode switching cycles and 1 discontinuous conduction mode switching cycle, or as shown in FIG. 4C, which comprises 1 boundary conduction mode switching cycle and 1 discontinuous conduction mode switching cycle. As the load continues to decrease, refer to FIGS. 4D-4E, which show the hybrid conduction mode cycle Tskip with N=1. That is, the cycle of the flyback converter operating in hybrid conduction mode comprises one discontinuous conduction mode switching cycle. For example, as the load decreases, the cycle of the flyback converter operating in hybrid conduction mode is smaller than the maximum value Tmax of the hybrid conduction mode cycle as shown in FIG. 4D, or it can be equal to the maximum value Tmax of the hybrid conduction mode cycle as shown in FIG. 4E. When the hybrid conduction mode cycle Tskip increases to the maximum value Tmax of the hybrid conduction mode cycle, it is forced to enter the next hybrid conduction mode cycle Tskip. As the load continues to decrease, the flyback converter works in the discontinuous conduction mode under light load condition. Schematically, under light load condition, the flyback converter first works in PWM mode, and the peak current decreases. As the load continues to decrease, the flyback converter works in Burst mode.

It should be noted that the maximum value Tmax of the hybrid conduction mode cycle is determined based on the minimum switching frequency allowed by the flyback converter. The set of the minimum switching frequency is to prevent the flyback converter from entering the audio. Schematically, the minimum switching frequency can be set to 25kHz, 30kHz, or any frequency between the two. Embodiments of the present application are not restricted by this.

The switch control circuit 130 is connected to the mode control circuit 120, and controls the switching states of the first transistor Q1 and the second transistor Q2 of the flyback converter under different modes.

Furthermore, the control circuit 100 also comprises an output feedback circuit 110. The output feedback circuit 110 generates an error compensation signal Vcomp based on the output feedback signal of the flyback converter. Schematically, the output feedback circuit 110 can generate an error compensation signal Vcomp based on the output feedback signal VFB representing the output voltage Vo, wherein two resistors (not shown in the drawing) connected in series between the output voltage Vo and the secondary ground can be used to obtain the output feedback signal VFB by detecting the voltage at the common terminal of the two resistors. It should be noted that this application does not limit the types and acquisition methods of output feedback signals. In other embodiments, the output feedback signal may also be a signal that characterizes the output current or the output power, etc.

Furthermore, the mode control circuit 120 obtains the load state of the flyback converter based on the error compensation signal Vcomp. Schematically, while the error compensation signal Vcomp is greater than the first set threshold Vcomp1, the load state is heavy load; while the error compensation signal Vcomp is less than the second set threshold Vcomp2, the load state is light load; while the error compensation signal Vcomp is less than the first set threshold Vcomp1 and greater than the second set threshold Vcomp2, the load is between light load and heavy load. The first set threshold Vcomp1 is greater than the second set threshold Vcomp2.

Furthermore, the control circuit 100 further comprises a current zero crossing detection circuit 140, which is used to obtain the moment when the magnetizing inductance current ILm of the flyback converter drops to zero during each switching cycle of the hybrid conduction mode cycle Tskip. while the duration between the start of the hybrid conduction mode cycle Tskip and the moment when the magnetizing inductance current ILm of the switching cycle drops to zero exceeds the time threshold, the mode control circuit 120 controls the switching cycle to operate in discontinuous conduction mode (DCM). The time threshold is equal to half of the product of the maximum value Tmax of the hybrid conduction mode cycle and the first duty cycle Duty, for example.

In other embodiments, the mode control circuit 120 controls the switching cycle to work in the discontinuous conduction mode (DCM) or the boundary conduction mode (BCM) while the duration between the start of the hybrid conduction mode cycle Tskip and the moment when the magnetizing inductance current ILm of the switching cycle drops to zero is equal to the time threshold.

In other embodiments, the mode control circuit 120 controls the switching cycle to work in the boundary conduction mode (BCM) while the duration between the start of the hybrid conduction mode cycle Tskip and the moment when the magnetizing inductance current ILm of the switching cycle drops to zero is less than the time threshold.

Furthermore, the mode control circuit 120 also obtains the first time Ton during the hybrid conduction mode cycle Tskip, and obtains the hybrid conduction mode cycle Tskip based on the first time Ton and the first duty cycle Duty. Wherein, the first time Ton starts from the beginning of the hybrid conduction mode cycle Tskip and ends at the moment when the magnetizing inductance current ILm of the flyback converter drops to zero in the Nth switching cycle. Furthermore, the hybrid conduction mode cycle Tskip is the quotient of the first time Ton and the first duty cycle Duty.

In other embodiments, the mode control circuit 120 also obtains the hybrid conduction mode cycle Tskip based on the maximum value Tmax of the hybrid conduction mode cycle. When the quotient of the first time Ton and the first duty cycle Duty is less than the maximum value Tmax of the hybrid conduction mode cycle, the hybrid conduction mode cycle Tskip is the quotient of the first time Ton and the first duty cycle Duty. Otherwise, the hybrid conduction mode cycle Tskip is the maximum value Tmax of the hybrid conduction mode cycle.

Schematically, the current zero crossing detection circuit 140 comprises a volt second balance detection circuit 141. The volt second balance detection circuit 141 is used to perform volt second balance detection in each switching cycle to obtain the volt second balance time, and also as the time when the magnetizing inductance current ILm drops to zero. Wherein, the volt second balance time represents that the charge flowing out of the auxiliary winding Naux during the conduction period of the first transistor Q1 of the flyback converter is equal to the charge flowing into the auxiliary winding Naux during the conduction period of the second transistor Q2 of the flyback converter.

In other embodiments, refer to FIG. 2, the difference between flyback converter 300 and flyback converter 200 lies in the control circuit. The control circuit 400 in the flyback converter 300 comprises a periodic control circuit 150 in addition to the control circuit 100, and a current zero crossing detection circuit 240 that comprises a voltage detection circuit 142 in addition to the current zero crossing detection circuit 140.

Furthermore, the volt second balance detection circuit 141 performs volt second balance detection and outputs a volt second balance signal in the hybrid conduction mode. The volt second balance signal represents that the charge flowing out of the auxiliary winding Naux during the conduction period of the first transistor Q1 and the charge flowing into the auxiliary winding Naux during the conduction period of the second transistor Q2 are equal in each switching cycle.

Schematically, during the conduction period of the first transistor Q1, the current Is flowing out of the auxiliary winding Naux through the sampling terminal VS is sampled by controlling the conduction period of the transistor Q10, and during the conduction period of the second transistor Q2, the current Is flowing into the auxiliary winding Naux through the sampling terminal VS is sampled by controlling the conduction period of the transistor Q10. Refer to FIG. 5, based on the charge balance method, when the charge Is*t flowing in through the sampling terminal VS during the conduction period of the second transistor Q2 is equal to the charge Is*t flowing out through the sampling terminal VS during the conduction period of the first transistor Q1, the volt second balance time t2 is obtained, and the output volt second balance signal indicates that the volt second balance is reached. In an alternative embodiment, the voltage Vaux of the auxiliary winding can be sampled to obtain the volt second balance time t2 when the volt second of area S2 is equal to the volt second of area S1.

Furthermore, in this embodiment, by detecting, e.g., the moment when the slope of the signal Vs representing the auxiliary winding voltage Vaux first reaches the slope threshold which is negative (the moment when the drain source voltage Vds1 of the first transistor Q1 reaches the inflection point in DCM mode in FIGS. 4A-4E) in the Nth switching cycle of the hybrid conduction mode cycle (which works in the discontinuous conduction mode), and using this as the moment when the magnetizing inductance current ILm drops to zero in the Nth switch cycle, the first time Ton is thus directly obtained.

The cycle control circuit 150 obtains the hybrid conduction mode cycle Tskip based on the first time Ton and the first duty cycle Duty. Furthermore, the hybrid conduction mode cycle Tskip is the quotient of the first time ton and the first duty cycle Duty.

Furthermore, refer to FIGS. 6 and 7, the cycle control circuit 150 comprises a first capacitor unit 151, a second capacitor unit 152, and a comparator U1.

The first capacitor unit 151 generates a first current I1 within the first time ton, and discharges the first capacitor C1 at the beginning of each hybrid conduction mode cycle, and then charges the first capacitor C1 through the first current I1. The second capacitor unit 152 provides a second current I2 and discharges the second capacitor C2 at the beginning of each hybrid conduction mode cycle, and then charges the second capacitor C2 through the second current I2. The comparator U1 generates a periodic control signal Tctrl based on the comparison between the voltage across the first capacitor C1 and the voltage across the second capacitor C2. The periodic control signal Tctrl represents a hybrid conduction mode cycle or a discontinuous conduction mode cycle . Wherein, the quotient of the second current I2 and the first current I1 is the first duty cycle Duty, and the capacitance values of the first capacitor C1 and the second capacitor C2 are equal.

Schematically, the first capacitor unit 151 comprises: a first capacitor C1; a first resistor R1; a first current source U2, schematically the first current source U2 is, e.g., a current mirror, comprising an eighth transistor and a ninth transistor. The control terminal of the eighth transistor is connected to its own first terminal and connected to the power supply voltage VCC through the first resistor R1. The control terminal of the ninth transistor is connected to the control terminal of the eighth transistor, and the first terminal of the ninth transistor is connected to the power supply voltage VCC. The second terminal of the ninth transistor is connected to the first terminal of the first capacitor C1, and the second terminal of the first capacitor C1 is grounded; the control terminal of the third transistor Q3 receives the first control signal Vduty. The first terminal of the third transistor Q3 is connected to the second terminal of the eighth transistor, and the second terminal of the third transistor Q3 is grounded; the first end of the fourth transistor Q4 is connected to the first end of the first capacitor C1, the second end of the fourth transistor Q4 is connected to the second end of the first capacitor C1, and the control terminal of the fourth transistor Q4 receives the second control signal Vpulse.

The second capacitor unit 152 comprises: a second capacitor C2; a second resistor R2; a second current source U3. Schematically, the second current source U3 is, e.g., a current mirror, including a fifth transistor and a sixth transistor. The control terminal of the fifth transistor is connected to its own first terminal and is connected to the power supply voltage VCC through the second resistor R2. The second terminal of the fifth transistor is grounded, and the control terminal of the sixth transistor is connected to the control terminal of the fifth transistor. The first terminal of the sixth transistor is connected to the power supply voltage VCC. The second terminal of the sixth transistor is connected to the first terminal of the second capacitor C2, and the second terminal of the second capacitor C2 is grounded; the first end of the seventh transistor Q7 is connected to the first end of the second capacitor C2, and the second end of the seventh transistor Q7 is connected to the second end of the second capacitor C2. The control terminal of the seventh transistor Q7 receives the second control signal Vpulse.

Wherein, the effective state of the first control signal Vduty is maintained for a first time ton, the second control signal Vpulse is a pulse signal at the beginning of each hybrid conduction mode cycle; the resistance values of the first resistor R1 and the second resistor R2 are equal, and the quotient of the current coefficients of the second current source U3 and the first current source U2 is the first duty cycle Duty. It should be noted that the second current source U3 and the first current source U2 can also be other current controlled current sources.

Refer to FIG. 6, which explains by taking an example of how to obtain the hybrid conduction mode cycle Tskip. The purpose of the second control signal Vpulse is to reset the voltage of capacitors C1 and C2 to zero at the beginning of each hybrid conduction mode cycle. The first capacitor C1 only charges during the first time ton, while the second capacitor C2 charges throughout the entire cycle. Throughout the entire cycle, the voltage across the first capacitor C1 remains higher than the voltage across the second capacitor C2 until the voltage across the second capacitor C2 reaches the voltage across the first capacitor C1, at which point the current cycle ends.

Furthermore, the switch control circuit 130 further comprises a parameter setting circuit 160. The parameter setting circuit 160 sets the first duty cycle Duty based on the error compensation signal Vcomp in both hybrid conduction mode and discontinuous conduction mode. The parameter setting circuit 160 also sets the peak current Vcs based on the error compensation signal Vcomp. The peak current Vcs is used at least for comparison with the inductor current sampling signal, and the first transistor Q1 is controlled to turn off when the inductor current sampling signal reaches the peak current Vcs.

Schematically, refer to FIG. 3, the Duty curve is formed of multiple first duty cycles Duty. The multiple first duty cycles are set according to different error compensation signals Vcomp. The Vcs curve is formed by multiple peak currents, and the multiple peak currents are set according to different error compensation signals Vcomp. Curve L1 represents the upper limit that the working frequency of the flyback converter can reach, while curve L2 represents the lower limit that the working frequency of the flyback converter can reach. Furthermore, while the error compensation signal Vcomp is less than or equal to the second set threshold Vcomp2, the first duty cycle Duty has a minimum value Duty-min. When the error compensation signal Vcomp is equal to the first set threshold Vcomp1, the first duty cycle Duty has its maximum value. When the error compensation signal Vcomp is greater than the second set threshold Vcomp2 and less than the first set threshold Vcomp1, the first duty cycle Duty increases as the error compensation signal Vcomp increases, wherein, the maximum value of the first duty cycle Duty is 100%.

Schematically, the switch control circuit 130 controls the switch cycle to work in the boundary conduction mode in the hybrid conduction mode, which includes: controlling the first transistor Q1 to turn on at the beginning of the boundary conduction mode switch cycle, controlling the second transistor Q2 to turn on after the first transistor Q1 is turned off, and controlling the second transistor Q2 to turn off by delaying the second time tZVS when the magnetizing inductance current ILm drops to zero (volt second balance time) within the switch cycle.

The switch control circuit 130 controls the switching cycle to work in the discontinuous conduction mode in the hybrid conduction mode, including: controlling the first transistor Q1 to turn on at the beginning of the discontinuous conduction mode switching cycle, controlling the second transistor Q2 to turn on after the first transistor Q1 is turned off, and controlling the second transistor Q2 to turn off at the moment when the magnetizing inductance current ILm drops to zero during the switching cycle (the moment of volt second balance or the moment when the slope of the signal Vs representing the auxiliary winding voltage Vaux first reaches the slope threshold which is negative), and maintaining the first transistor Q1 to turn off until the hybrid conduction mode cycle Tskip ends.

Furthermore, in the hybrid conduction mode, the switch control circuit 130 determines whether the current time is greater than the time threshold (indicated by the dashed line indicated by an arrow in the drawing) at the moment when it detects that the magnetizing inductance current ILm drops to zero. If the current time is greater than the time threshold, it is the first time, and the switch control circuit 130 controls to turn off the second transistor Q2 while keeping the first transistor Q1 turned off. In the case where the current time is less than the time threshold, the switch control circuit 130 delays the second time to turn off the second transistor Q2, and controls the first transistor Q1 and the second transistor Q2 in the flyback converter to alternate zero voltage conduction in the next switching cycle. When the current time is equal to the time threshold, the switch control circuit 130 can delay the second time to turn off the second transistor Q2, and control the first transistor Q1 and the second transistor Q2 in the flyback converter to work in the discontinuous conduction mode in the next switching cycle. Alternatively, in the case where the current time is equal to the time threshold, the current time is the first time, and then the switch control circuit 130 controls to turn off the second transistor Q2 and keep the first transistor Q1 turned off.

In the case of hybrid conduction mode N>1, schematically, refer to FIG. 4A. During the first three switching cycles, the time threshold (indicated by the dashed line indicated by an arrow in the figure) is not reached each time the volt second balance is reached. Until the current time is greater than the time threshold (indicated by the dashed line indicated by an arrow in the figure) when the volt second balance is reached in the fourth switching cycle, that is, the moment when the volt second balance output volt second balance signal is reached in the fourth switching cycle (or the moment when the slope of the signal Vs representing the auxiliary winding voltage Vaux first reaches the slope threshold which is negative in the fourth switching cycle) is the first time ton; afterwards, the switch control circuit 130 controls to turn off the second transistor Q2 and keep the first transistor Q1 turned off for a duration Toff until the next hybrid conduction mode cycle Tskip begins. Wherein, the start time of the next hybrid conduction mode cycle Tskip is determined based on the current hybrid conduction mode cycle Tskip.

It should be noted that the switch control circuit 130 controls the first transistor Q1 and the second transistor Q2 in the flyback converter 200 to alternatively turn on at zero voltage during the first time ton at the beginning of each hybrid conduction mode cycle Tskip in the hybrid conduction mode, which means that at the beginning of each hybrid conduction mode cycle, the first transistor Q1 is controlled to turn on, and then, e.g., based on the inductor current sampling signal representing the current flowing through the first transistor Q1 and the peak current Vcs, the first transistor Q1 is controlled to turn off to control the peak of the magnetizing inductance current ILm. And the second transistor Q2 is controlled to turn on after the first transistor Q1 is turned off, and the first transistor Q1 is turned after reaching the volt second balance and delay for tZVS (the second time). Then continue to control the first transistor Q1 and the second transistor Q2 to alternatively turn on at zero voltage.

In the case of hybrid conduction mode N=1, refer to FIG. 4D, from the beginning of the hybrid conduction mode cycle to the moment of volt second balance or the moment when the slope of the signal Vs representing the auxiliary winding voltage Vaux first reaches the slope threshold which is negative, the duration between them is greater than the time threshold (the time indicated by the dashed line indicated by an arrow in the drawing). That is, the moment when the volt second balance signal is output or the moment when the signal Vs representing the auxiliary winding voltage Vaux first shows a negative slope reaching the slope threshold is the first time ton. Then, the switch control circuit 130 controls the second transistor Q2 to turn off and keep the first transistor Q1 turned off and kept for a time Toff until the next hybrid conduction mode cycle Tskip begins. Wherein, the start time of the next hybrid conduction mode cycle Tskip is determined based on the current hybrid conduction mode cycle Tskip. But when the hybrid conduction mode cycle Tskip reaches the maximum value Tmax of the hybrid conduction mode cycle, as shown in FIG. 4E, after the first time ton, the switch control circuit 130 controls the second transistor Q2 to turn off and keep the first transistor Q1 turned off until the next hybrid conduction mode cycle Tskip begins. Wherein, the start time of the next hybrid conduction mode cycle Tskip is determined based on the maximum value Tmax of the hybrid conduction mode cycle.

It should be noted that during the discontinuous conduction mode switching cycle in the hybrid conduction mode, the switch control circuit 130 controls the first switching transistor Q1 in the flyback converter to turn on and controls the second switching transistor Q2 to turn on after the first transistor Q1 is turned off within the first time Ton of the switching cycle, and this refers to that at the beginning of the switching cycle, it controls the first transistor Q1 to turn on, and then compares the inductor current sampling signal with the peak current Vcs to control the first switching transistor Q1 to turn off, and controls the second transistor Q2 to turn on after the first transistor Q1 is turned off.

The signal VS that characterizes the voltage of the auxiliary winding is, e.g., a voltage signal.

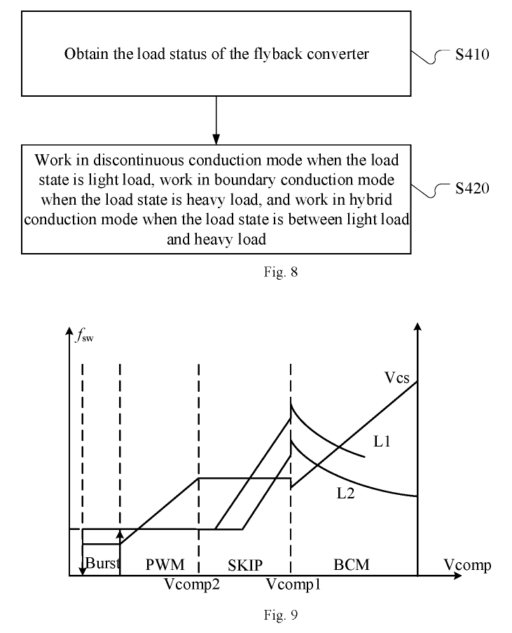

FIG. 8 shows a flowchart of a control method of a flyback converter provided according to an embodiment of the present application. Refer to FIG. 8, the control method can be executed in, e.g., control circuit 100 or control circuit 400. The control method comprises the following steps:

Step S410: obtain the load status of the flyback converter. Schematically, the step of obtaining the load state of the flyback converter comprises: generating an error compensation signal based on the output feedback signal of the flyback converter; and obtaining the load state of the flyback converter based on the error compensation signal. Wherein, while the error compensation signal is greater than the first set threshold, the load state is heavy load; while the error compensation signal is less than the second set threshold, the load state is light load; while the error compensation signal is less than the first set threshold and greater than the second set threshold, the load state is between heavy load and light load; when the first set threshold is greater than the second set threshold, the load state is between heavy load and light load.

Step S420: work in discontinuous conduction mode while the load state is light load, work in boundary conduction mode while the load state is heavy load, and work in hybrid conduction mode while the load state is between light load and heavy load. The hybrid conduction mode cycle comprises N switching cycles, with the first N-1 switching cycles working in the boundary conduction mode and the Nth switching cycle working in the discontinuous conduction mode. Wherein, according to the set maximum value of the hybrid conduction mode cycle and the set first duty cycle, each switching cycle within the hybrid conduction mode cycle is controlled to work in the boundary conduction mode or the discontinuous conduction mode, where N is a positive integer.

Furthermore, controlling each switching cycle within the combined conduction mode cycle to work in boundary conduction mode or discontinuous conduction mode based on the set maximum value of the hybrid conduction mode cycle and the set first duty cycle comprises: obtaining the moment when the magnetizing inductance current of the flyback converter drops to zero during each switching cycle within the hybrid conduction mode cycle; and while the duration between the start of the hybrid conduction mode cycle and the moment when the magnetizing inductance current of the switching cycle drops to zero is greater than the time threshold, the switching cycle is controlled to operate in the discontinuous conduction mode. The time threshold is equal to half of the product of the maximum value of the hybrid conduction mode cycle and the first duty cycle.

Furthermore, it further comprises: while the duration between the start of the combined conduction mode cycle and the moment when the magnetizing inductance current drops to zero during the switching cycle is equal to the time threshold, controlling the switching cycle to work in the boundary conduction mode or the discontinuous conduction mode; while the duration between the start of the hybrid conduction mode cycle and the moment when the magnetizing inductance current drops to zero during the switching cycle is less than the time threshold, controlling the switching cycle to work in boundary conduction mode.

Furthermore, the flyback converter comprises a first transistor and a second transistor. Controlling the switching cycle to work in the boundary conduction mode under the hybrid conduction mode comprises: controlling the first transistor to turn on at the beginning of the switching cycle; controlling the second transistor to turn on after the first transistor is turned off; at the moment when the magnetizing inductance current drops to zero during the switching cycle, delaying the second time and controlling the second transistor to turn off.

Furthermore, controlling the switching cycle to work in the discontinuous conduction mode under hybrid conduction mode comprises: controlling the first transistor to turn on at the beginning of the switching cycle; controlling the second transistor to turn on after the first transistor is turned off; at the moment when the magnetizing inductance current drops to zero during the switching cycle, controlling the second transistor to turn off and keep the first transistor turned on off until the end of the hybrid conduction mode cycle.

Furthermore, the control method also comprises obtaining a first time during the hybrid conduction mode cycle, and the first time starts from the hybrid conduction mode cycle and ends when the magnetizing inductance current of the flyback converter drops to zero during the Nth switching cycle; obtaining the hybrid conduction mode cycle based on the first time and first duty cycle. The hybrid conduction mode cycle is the quotient of the first time and the first duty cycle.

Furthermore, the hybrid conduction mode cycle is obtained based on the maximum value of the hybrid conduction mode cycle. When the quotient of the first time and the first duty cycle is less than the maximum value of the hybrid conduction mode cycle, the hybrid conduction mode cycle is the quotient of the first time and the first duty cycle. Otherwise, the hybrid conduction mode cycle is the maximum value of the hybrid conduction mode cycle.

Furthermore, the method for obtaining the moment when the magnetizing inductance current of the flyback converter drops to zero in each switching cycle of the hybrid conduction mode cycle comprises: performing volt second balance detection in each switching cycle to obtain the volt second balance moment, and using it as the moment when the magnetizing inductance current drops to zero is detected. The volt second balance moment represents that the charge flowing out of the auxiliary winding during the conduction period of the first switching transistor of the flyback converter is equal to the charge flowing into the auxiliary winding during the conduction period of the second transistor of the flyback converter.

Furthermore, the method for obtaining the moment when the magnetizing inductance current of the flyback converter drops to zero during the Nth switching cycle comprises: performing volt second balance detection during the Nth switching cycle to obtain the volt second balance moment, and using it as the moment when the magnetizing inductance current drops to zero is detected; alternatively, at the Nth switching cycle, detecting the moment when the slope of the signal representing the auxiliary winding voltage first reaches the slope threshold at the Nth switching cycle, and using it as the moment when the magnetizing inductance current drops to zero, wherein the slope threshold is negative.

Furthermore, the control method further comprises: in the hybrid conduction mode, setting a first duty cycle based on the error compensation signal, wherein while the error compensation signal is greater than the second set threshold and less than the first set threshold, the first duty cycle increases as the error compensation signal increases.

Furthermore, while the error compensation signal is equal to the first set threshold, the first duty cycle has a maximum value, and the maximum value of the first duty cycle is 100%.

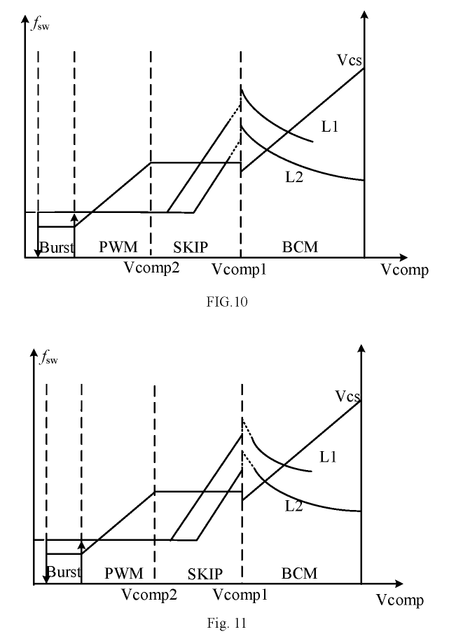

FIG. 9 shows a waveform diagram of another peak current in the control circuit of the flyback converter provided according to an embodiment of the present application. FIG. 10 shows a waveform diagram of another peak current in the control circuit of the flyback converter provided according to an embodiment of the present application. FIG. 11 shows a waveform diagram of still another peak current in the control circuit of the flyback converter provided according to an embodiment of the present application.

Refer to FIG. 9, the control method of the flyback converter provided in this application adds control hysteresis to avoid switching back and forth between the boundary conduction mode and the hybrid conduction mode at the critical load point (error compensation signal is equal to the first set threshold Vcomp1). Schematically, while the error compensation signal drops to the first set threshold, the peak current Vcs suddenly increases, resulting in a decrease in the equivalent switching frequency and a corresponding increase in power mutation.

Refer to FIG. 10, the frequency curve of the boundary conduction mode switching to the hybrid conduction mode is shown as the load decreases from high to low. Refer to FIG. 11, the frequency curve of the hybrid conduction mode switching to the boundary conduction mode is shown as the load increases from low to high. Wherein, the dotted line represents the switching point area, and the steady-state working point will not work in the dotted line area. Take the frequency curve of switching from boundary conduction mode to hybrid conduction mode with the load decreasing from high to low as an example, while the error compensation signal Vcomp decreases from high to the first set threshold Vcomp1, the peak current suddenly increases, causing the working frequency to decrease rapidly. Therefore, after switching from boundary conduction mode to hybrid conduction mode, the flyback converter will not easily jump due to slight changes in the error compensation signal.

The flyback converter and its control circuit, as well as the control method provided in this disclosure, obtain the load state of the flyback converter and control it to work in different modes under different load states. while the load state is between light load and heavy load, it works in a hybrid conduction mode. The hybrid conduction mode cycle comprises N switching cycles, including N-1 switching cycles for boundary conduction mode and 1 switching cycle for discontinuous conduction mode. The present application controls each switching cycle within the hybrid conduction mode cycle to work in boundary conduction mode or discontinuous conduction mode by setting the maximum value of the hybrid conduction mode cycle and the first duty cycle, in order to adaptively control each switching cycle in the hybrid conduction mode and improve the system efficiency of the flyback converter under load conditions between light load and heavy load.

Furthermore, in the present application, while the error compensation signal drops to the first set threshold, the peak current suddenly increases to add control hysteresis and avoid switching back and forth between the boundary conduction mode and the hybrid conduction mode.

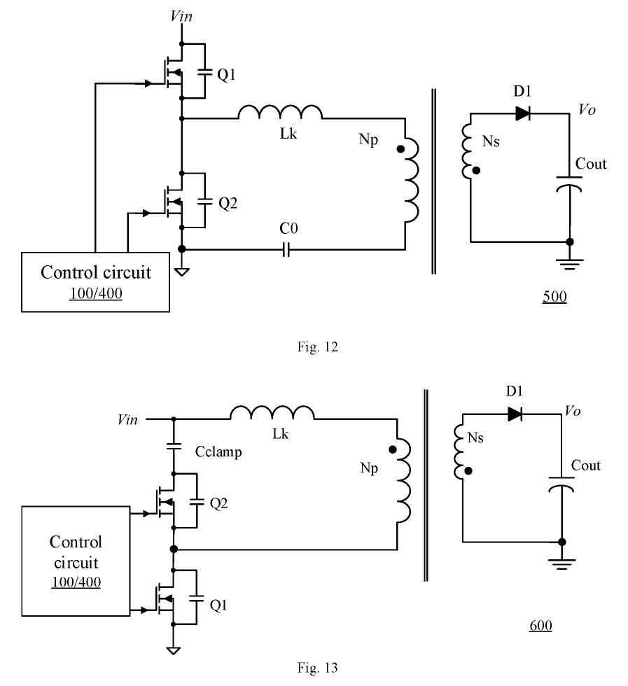

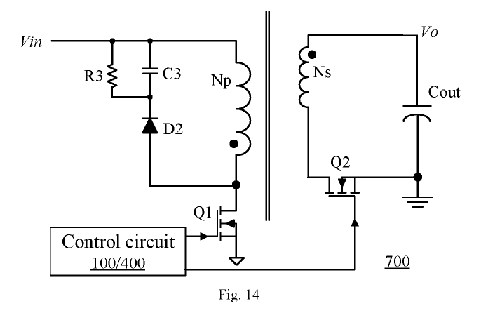

FIG. 12 shows a structural schematic view of another flyback converter according to an embodiment of the present application. FIG. 13 shows a structural schematic view of another flyback converter according to an embodiment of the present application. FIG. 14 shows a structural schematic view of still another flyback converter according to an embodiment of the present application.

It should be noted that both FIGS. 1 and 2 are examples of asymmetric half bridge flyback converters of the first transistor Q1 located on the low side. In other embodiments, it can also be an asymmetric half bridge flyback converter 500 of the first transistor Q1 located on the high side, as shown in FIG. 12. The above embodiments are all illustrated using an asymmetric half bridge flyback converter as an example, however, it can be understood that the present application is not limited to this. Based on similar working principles, the scheme of the above embodiment can also be applied to other topologies of flyback converters, such as the active clamp flyback converter 600 shown in FIG. 13, the zero voltage switching flyback converter 700 shown in FIG. 14, and so on. Wherein, in FIG. 13, the second transistor Q2 serves as a clamp switch. One end of the second transistor Q2 is connected to the clamp capacitor Cclamp, and the other end of the second transistor Q2 is connected to the common terminal of the first transistor Q1 and the primary winding of the transformer. In FIG.14, the first transistor Q1 is connected to the primary winding, and the second transistor Q2 is connected to the secondary winding.

It should be noted that the control circuit in flyback converters 500, 600, and 700 can be either control circuit 100 or control circuit 400.

The above implementation methods do not constitute a limitation on the protection scope of the technical solution. Any modifications, equivalent substitutions, and improvements made within the spirit and principles of the above implementation shall be included within the protection scope of the technical solution.

What is claimed is:

1. A control method of a flyback converter, comprising:
obtaining a load state of the flyback converter;
working in a discontinuous conduction mode while the load state is light load;
working in a boundary conduction mode while the load state is heavy load; and
working in a hybrid conduction mode while the load state is between light load and heavy load; a hybrid conduction mode cycle comprising N switching cycles, with the first N-1 switching cycles working in the boundary conduction mode while the Nth switching cycle working in the discontinuous conduction mode; wherein each switching cycle in the hybrid conduction mode cycle is controlled to work in the boundary conduction mode or the discontinuous conduction mode according to a set maximum value of the hybrid conduction mode cycle and a set first duty cycle, wherein N is a positive integer.

2. The control method of a flyback converter of claim 1, wherein controlling each switching cycle in the hybrid conduction mode cycle to work in the boundary conduction mode or the discontinuous conduction mode according to the set maximum value of the hybrid conduction mode cycle and the set first duty cycle comprises:
obtaining a moment when the magnetizing inductance current of the flyback converter drops to zero in each switching cycle of the hybrid conduction mode cycle; and
while a duration between start time of the hybrid conduction mode cycle and the moment when the magnetizing inductance current of the switching cycle drops to zero is greater than a time threshold, controlling the switching cycle to work in the discontinuous conduction mode;
the time threshold is equal to half of the product of the maximum value of the hybrid conduction mode cycle and the first duty cycle.

3. The control method of a flyback converter of claim 2, further comprising:
while the duration between the start time of the hybrid conduction mode cycle and the moment when the magnetizing inductance current drops to zero during the switching cycle is equal to the time threshold, controlling the switching cycle to work in either the boundary conduction mode or the discontinuous conduction mode;
while the duration between the start time of the hybrid conduction mode cycle and the moment when the magnetizing inductance current drops to zero during the switching cycle is less than the time threshold, controlling the switching cycle to work in the boundary conduction mode.

4. The control method of a flyback converter of claim 2, wherein the flyback converter comprises a first transistor and a second transistor, and controlling the switching cycle to work in the boundary conduction mode under the hybrid conduction mode comprises:
controlling the first transistor to turn on at the beginning of the switching cycle;
controlling the second transistor to turn on after the first transistor is turned off;
controlling the second transistor to turn off by delaying a second time when the magnetizing inductance current drops to zero during the switching cycle.

5. The control method of a flyback converter of claim 2, wherein the flyback converter comprises a first transistor and a second transistor, and controlling the switching cycle to work in the discontinuous conduction mode under the hybrid conduction mode comprises:
controlling the first transistor to turn on at the beginning of the switching cycle;
controlling the second transistor to turn on after the first transistor is turned off;
at the moment when the magnetizing inductance current drops to zero during the switching cycle, controlling the second transistor to turn off and keeping the first transistor turned off until the hybrid conduction mode cycle ends.

6. The control method of a flyback converter of claim 1, wherein the control method further comprises:
obtaining a first time during the hybrid conduction mode cycle, which starts from the beginning of the hybrid conduction mode cycle and ends at the moment when the magnetizing inductance current of the flyback converter drops to zero during the Nth switching cycle;
obtaining the hybrid conduction mode cycle based on the first time and the first duty cycle.

7. The control method of a flyback converter of claim 6, wherein the hybrid conduction mode cycle is the quotient of the first time and the first duty cycle.

8. The control method of a flyback converter of claim 7, wherein the hybrid conduction mode cycle is further obtained based on the maximum value of the hybrid conduction mode cycle,
when the quotient of the first time and the first duty cycle is less than the maximum value of the hybrid conduction mode cycle, the hybrid conduction mode cycle is the quotient of the first time and the first duty cycle; otherwise, the hybrid conduction mode cycle is the maximum value of the hybrid conduction mode cycle.

9. The control method of a flyback converter of claim 2, wherein the method of obtaining the moment when the magnetizing inductance current of the flyback converter drops to zero in each switching cycle within the hybrid conduction mode cycle comprises:
performing volt second balance detection in each switching cycle to obtain volt second balance time, which is used as the time of detecting that the magnetizing inductance current drops to zero; wherein the volt second balance time represents that the charge flowing out of the auxiliary winding during the conduction period of the first transistor of the flyback converter is equal to the charge flowing into the auxiliary winding during the conduction period of the second transistor of the flyback converter.

10. The control method of a flyback converter of claim 6, wherein the method of obtaining the moment when the magnetizing inductance current of the flyback converter drops to zero during the Nth switching cycle comprises:
performing volt second balance detection within the Nth switching cycle to obtain the volt second balance time, which is used as the time detecting that the magnetizing inductance current drops to zero; the volt second balance time represents that the charge flowing out of the auxiliary winding during the conduction period of the first transistor of the flyback converter is equal to the charge flowing into the auxiliary winding during the conduction period of the second transistor of the flyback converter;
or, detecting the moment when the slope of the signal representing the auxiliary winding voltage first reaches the slope threshold at the Nth switching cycle, and using it as the moment when the magnetizing inductance current drops to zero, wherein the slope threshold is negative.

11. The control method of a flyback converter of claim 1, wherein obtaining the load state of the flyback converter comprises:
generating an error compensation signal based on the output feedback signal of the flyback converter; and
obtaining the load state based on the error compensation signal,
wherein, the load state is heavy load while the error compensation signal is greater than a first set threshold, and the load state is light load while the error compensation signal is less than a second set threshold, the load state is between light load and heavy load while the error compensation signal is less than the first set threshold and greater than the second set threshold, and the first set threshold is greater than the second set threshold.

12. The control method of a flyback converter of claim 11, wherein the control method further comprises:
in the hybrid conduction mode, setting the first duty cycle according to the error compensation signal, wherein while the error compensation signal is greater than the second set threshold and less than the first set threshold, the first duty cycle increases as the error compensation signal increases.

13. The control method of a flyback converter of claim 12, wherein while the error compensation signal is equal to the first set threshold, the first duty cycle has a maximum value, and the maximum value of the first duty cycle is 100%.

14. The control method of a flyback converter of claim 11, wherein the peak current suddenly increases while the error compensation signal drops to the first set threshold.

15. A control circuit of a flyback converter, the flyback converter comprising a first transistor and a second transistor, wherein the control circuit comprises:
a mode control circuit, obtaining a load state of the flyback converter, controlling it to work in the discontinuous conduction mode while the load state is light load, controlling it to work in the boundary conduction mode while the load state is heavy load, and controlling it to work in the hybrid conduction mode while the load state is between light load and heavy load; the hybrid conduction mode cycle comprises N switching cycles, with the first N-1 switching cycles working in the boundary conduction mode and the Nth switching cycle working in the discontinuous conduction mode; the mode control circuit also controls each switching cycle within the hybrid conduction mode cycle to work in either the boundary conduction mode or the discontinuous conduction mode based on a set maximum value of the hybrid conduction mode cycle and a set first duty cycle, where N is a positive integer; and
a switch control circuit, connected to the mode control circuit, controlling the switching states of the first transistor and the second transistor.

16. The control circuit of a flyback converter of claim 15, further comprising:
a current zero crossing detection circuit, obtaining the moment when the magnetizing inductance current of the flyback converter drops to zero in each switching cycle of the hybrid conduction mode cycle,
while the duration between the start of the hybrid conduction mode cycle and the moment when the magnetizing inductance current of the switching cycle drops to zero is greater than a time threshold, the mode control circuit controls the switching cycle to operate in the discontinuous conduction mode,
the time threshold is equal to half of the product of the maximum value of the hybrid conduction mode cycle and the first duty cycle.

17. The control circuit of a flyback converter of to claim 15, further comprising:
an output feedback circuit, generating an error compensation signal based on the output feedback signal of the flyback converter;
the mode control circuit obtains the load state of the flyback converter based on the error compensation signal; wherein, while the error compensation signal is greater than a first set threshold, the load state is heavy load; while the error compensation signal is less than a second set threshold, the load state is light load; while the error compensation signal is less than the first set threshold and greater than the second set threshold, the load state is between light load and heavy load; the first set threshold is greater than the second set threshold.

18. The control circuit of a flyback converter of claim 15, further comprising:
a cycle control circuit, obtaining the hybrid conduction mode cycle based on a first time and the first duty cycle,
wherein, the mode control circuit obtains the first time, which starts from the beginning of the hybrid conduction mode cycle and ends at the moment when the magnetizing inductance current of the flyback converter drops to zero in the Nth switching cycle.

19. The control circuit of a flyback converter of claim 18, wherein the cycle control circuit comprises:
a first capacitor unit, comprising a first capacitor; the first capacitor unit generates a first current within the first time and discharges the first capacitor at the beginning of each hybrid conduction mode cycle, and then charges the first capacitor by the first current;
a second capacitor unit, comprising a second capacitor; the second capacitor unit provides a second current and discharges the second capacitor at the beginning of each hybrid conduction mode cycle, and then charges the second capacitor through the second current; and
a comparator, generating a periodic control signal based on the comparison result between the voltage across the first capacitor and the voltage across the second capacitor, and the periodic control signal represents a hybrid conduction mode cycle or a discontinuous conduction mode cycle,
wherein, the quotient of the second current and the first current is the first duty cycle, and the capacitance values of the first capacitor and the second capacitor are equal.

20. The control circuit of a flyback converter of claim 19, wherein,
the first capacitor unit further comprises:
a first resistor;
a first current source, comprising an eighth transistor and a ninth transistor; the control terminal of the eighth transistor is connected to its own first terminal and connected to the power supply voltage through the first resistor, the control terminal of the ninth transistor is connected to the control terminal of the eighth switch tube, and the first terminal of the ninth transistor is connected to the power supply voltage, the second terminal of the ninth transistor is connected to the first terminal of the first capacitor, and the second terminal of the first capacitor is grounded;
a third transistor, the control end of which receives a first control signal, the first end of which is connected to the second end of the eighth transistor, and the second end of which is grounded;
a fourth transistor, the first end of which is connected to the first end of the first capacitor, the second end of which is connected to the second end of the first capacitor, and the control terminal of which receives a second control signal,
the second capacitor unit further comprises:
a second resistor;
a second current source, comprising a fifth transistor and a sixth transistor, wherein the control terminal of the fifth transistor is connected to its own first terminal and connected to the power supply voltage via the second resistor, the second terminal of the fifth transistor is grounded, the control terminal of the sixth transistor is connected to the control terminal of the fifth transistor, the first terminal of the sixth transistor is connected to the power supply voltage, the second terminal of the sixth transistor is connected to the first terminal of the second capacitor, and the second terminal of the second capacitor is grounded;
a seventh transistor, the first end of which is connected to the first end of the second capacitor, the second end of which is connected to the second end of the second capacitor, and the control terminal of which receives a second control signal,
wherein, the effective state of the first control signal is maintained for the first time, the second control signal is a pulse signal at the beginning of each hybrid conduction mode cycle, the resistance values of the first resistor and the second resistor are equal, and the quotient of the mirror coefficients of the second current source and the first current source is the first duty cycle.

21. A flyback converter comprising the control circuit of a flyback converter of claim 15.
